(19) United States
(12) Patent Application Publication
(10) Pub. No.: US 2003/0226036 A1
(43) Pub. Date: Dec. 4, 2003

(54) Method and apparatus for single sign-on authentication

(75) Inventors: John A. Bivens, Troy, NY (US); Suresh N. Chari, Tarrytown, NY (US); James Ryan Giles, Yorktown Heights, NY (US); Reiner Sailer, Clifton, NJ (US); Dinesh C. Verma, Mount Kisco, NY (US)

Correspondence Address: Anne Vachon Dougherty, 3173 Cedar Road, Yorktown Heights, NY, 10598, US

(73) Assignee: International Business Machines Corporation, Armonk, NY

(21) Appl. No.: 10/159,416

(22) Filed: May 30, 2002

(51) Int. Cl. H04L 9/32

(52) U.S. Cl. 713/201; 713/182

(57) ABSTRACT

A method and apparatus for enabling a client to use a single set of credentials to access multiple secure applications at servers. A proxy authentication application at the server intercepts all requests for applications that require authentication, and initiates an authentication procedure with a proxy authentication application installed at the client. User credentials provided by the client authenticator are used by the server authenticator to determine the access credentials that should be forwarded to the server application on behalf of the users. The method allows per-user and per-application authentication decisions to be made at a system level rather than at an application level, even for legacy applications that are designed to require authentication at the application level, without modification to legacy client or server applications.

### FIELD OF THE INVENTION

This invention is directed to the field of computer networks. It is more particularly directed to performing authentication in computer networks such as corporate intranets or the Internet, and to easing the burden on administrators and clients who interact with multiple access-protected software applications.

### BACKGROUND OF THE INVENTION

Much of the communication in computer networks involves at least one client making requests to a server, and the server responding to the client's request. A server is defined as any device or collection of devices (e.g., datastore, directory, machines, and software) that communicates with a client over a computer network, usually either performing functions for the client or providing data to the client.

In many environments, especially enterprise environments, access to software applications and data on servers needs to be provided in a secure manner. Often, to achieve this security, client software applications must be configured with different credentials according to the application and the user. Necessarily, therefore, administrators must distribute different security credential files for different applications to each client, and in many cases distribute different application configurations. Further, client users often must also maintain credentials such as passwords for each of the secured software applications that are used.

Existing authentication mechanisms include the Kerberos scheme as defined in the Internet Standard RFC 1510 (The Kerberos Network Authentication Service V5) which provides a token-based mechanism for authentication. The client first requests a token for the service from a central token server and submits this token with the service request to the server application. The scheme requires that both the client and the server applications be modified to use the token.

Another existing authentication mechanism is the IBM/Tivoli Policy Director WEBSEAL, which offers a single sign-on solution for WWW-services. In WEBSEAL, an intermediate proxy server mediates any service requests and authenticates the users before forwarding requests along to the server applications. The WEBSEAL system offers centralized access control to unprotected server applications but does not help with server applications that require user authentication and which implement their own access control.

Existing single sign-on solutions require client-side application modifications server-side application modifications, or both. Existing single sign-on servers additionally require the storing of application-specific authentication information at a central site, which may represent a weak security point. Such modifications are, therefore, not feasible or desirable for existing client and server systems.

In order to simplify the task of software configuration and distribution, it would be highly desirable to reduce the total number of configuration distributions to be only one per user, rather than one per user per application.

It is therefore an object of the present invention to provide a system and method for a client application to access an access-controlled server application running on a server system.

It is a further object of the invention to provide a system and method to enable a client application to access any access-controlled server application running on a server system without the need for a separate software configuration for each user for each server application.

It is a further object of the invention to reduce the administrative burden of distributing user identifiers and passwords to clients for multiple server applications without modifying the server applications.

It is a further aspect of the invention to reduce the burden on users of client applications by allowing them to use one credential to access many server applications on the same server system without modifying the client applications.

### SUMMARY OF THE INVENTION

The foregoing and other objects are realized by the present invention which provides a token-based authentication mechanism allowing a client to use a single set of credentials to access multiple access-controlled applications at servers. It provides a system and method for a user with a standard software configuration to access any number of applications which require independent authentication, whereby there is no need to individually configure each application with the user's identity and credentials. The inventive approach can apply to software applications on multiple servers across a domain. The system and method allow per-user and per-application authentication decisions to be made at a system level rather than at an application level, even for legacy applications that are designed to require authentication at the application level. The invention does not require modification to legacy client or server applications.

One use for this invention relates to simplifying security, administration, and application roll-out in enterprise networks having several client-server applications requiring authentication.

In an example of the invention, a client would use the system and method disclosed herein to gain access to access-controlled applications on a server.

### BRIEF DESCRIPTION OF THE DRAWINGS

The foregoing and other objects, features, and advantages of the present invention will become apparent upon further consideration of the following detailed description of the invention when read in conjunction with the figures wherein:

FIG. 1 provides a block diagram of an environment for implementing the present invention having a client system, client application, server system, and server application;

FIG. 2 is a block diagram of the entities which implement the present invention;

FIG. 3 shows one embodiment of the invention illustrating a technique for enabling a client application to access a server application using the client authenticator and server authenticator of FIG. 2 to control access to the server application;

FIG. 4 shows another embodiment of the invention wherein the server authenticator is installed as a proxy on the same server system as the server application and the client authenticator is installed on the same client system as the client application;

FIG. 5 provides a flowchart illustrating the process steps for the server authenticator of FIG. 4 to implement the present invention;

FIG. 6 is a flowchart illustrating the process steps for the client authenticator of FIG. 4 to implement the present invention;

FIG. 7 shows another embodiment of the invention for enabling a client application to access a server application when the server authenticator is a proxy installed on the server system and the client authenticator is installed on a client-side proxy system different from the client system running the client application;

FIG. 8 is a flowchart that illustrates the actions taken by the client authenticator for the embodiment shown in FIG. 7; and

FIG. 9 is a logical diagram illustrating the sequence of events for the embodiment of the invention shown in FIG. 7.

### DETAILED DESCRIPTION OF THE INVENTION

The present invention enables a client application to access an access controlled server application on a server system. A typical environment in which the access occurs is illustrated in FIG. 1 which illustrates a client system and a server system connected to a core network such as an intranet.

The client system 105 and the server system 115 are connected to a core network 100. The client system and server system can be directly connected to the core network as exemplified in the figure, or can be connected via intermediary firewalls, routers, and subnetworks. There is at least one client application 110 running on the client system and at least one server application 120 running on one or several servers in the server system.

Typically client applications need to be pre-configured with access credentials or the user of the client application must provide credentials if a client application is to access an access-controlled server application. Server applications normally do not share access-control information so that separate credentials are needed to access each server application. Server application administrators and server system administrators thus face the burden of maintaining user credentials for each such application, and of communicating those credentials to users and client systems when they need to be updated. For client applications that use pre-configured credentials, administrators or users must make changes to the applications if the credentials change. Users must also maintain their credentials for each server application and enter them each time client applications need access to access-controlled server applications. To reduce the burden on server administrators and users, a system is needed that enables client applications access to access-controlled server applications without the need for users to maintain and enter credentials for each server application and without the need for server administrators to maintain credentials for each server application. Such a mechanism optimally does not require changes to the client applications, which would be both expensive and difficult to implement since it would require replacing existing client applications.

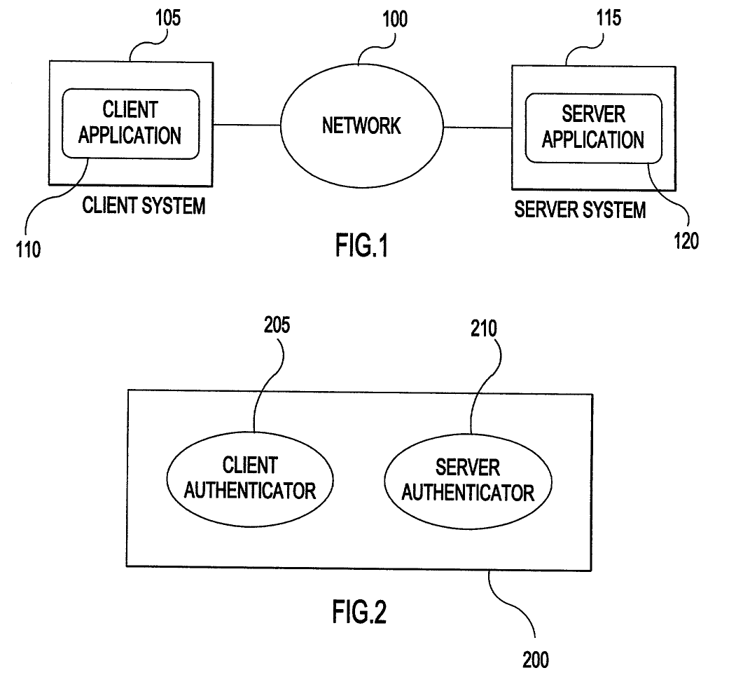

The present invention enables client applications to access access-controlled server applications without the client system having to provide credentials for each server application. FIG. 2 shows the inventive system, comprising the entities that implement the invention disclosed herein. The inventive system 200 includes client authenticator and server authenticator components which may be distributed among client systems, server systems, server-side proxy systems, and client-side proxy systems. Additionally, server authenticator components of the machine may be integrated into server applications. Any system 200 implementing this invention consists of a client authenticator 205 and a server authenticator 210. In some implementations of the invention, the server authenticator 210 may be integrated into one or more server applications 120.

In operation, the server authenticator 210 intercepts client application requests for server applications, and makes an authentication request to the client authenticator 205. The server authenticator enables access to the server application based on user credentials provided by the client authenticator 205, as further detailed below. The server authenticator may additionally translate the user credentials provided by the client authenticator into credentials understood by the requested server application. The client authenticator 205 determines the user of the client application, authenticates the user if necessary, determines the user credentials, and then sends the user credentials to the server authenticator.

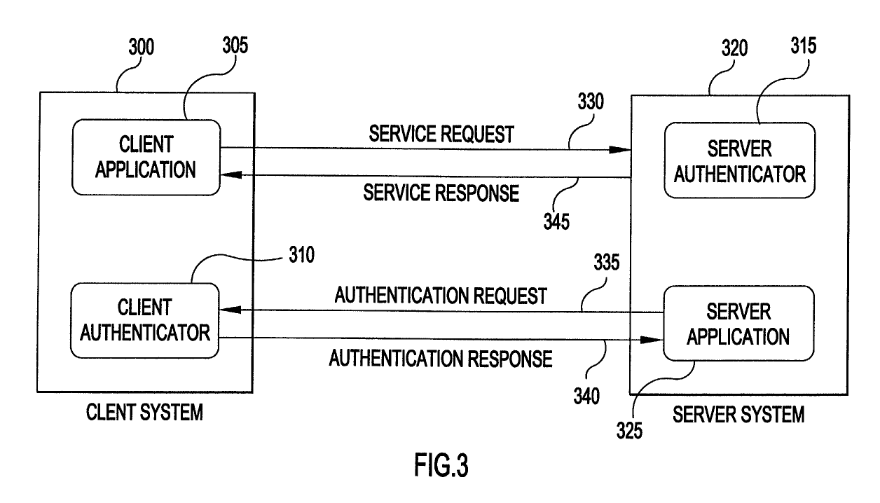

FIG. 3 shows a first embodiment of the invention illustrating a technique for enabling a client application to access a server application using the client authenticator and server authenticator to control access to the server application. In this embodiment, client application(s) 305 and the client authenticator 310 are running on the client system 300. Server application(s) 315 and the server authenticator 325 are running on the server system 320.

A client application 305 sends a service request 330 to the server system to access a server application 315. The server authenticator 325 intercepts the service request 330 and generates an authentication request 335 to the client authenticator 310 on the client system 300. The client authenticator determines the user identifier that matches the client application request, authenticates the user if necessary, and sends user credentials to the server authenticator in the authentication response 340.

The server authenticator uses the credentials provided to authenticate the user against the server application 315, possibly by translating the credentials into a form understood by the server application using a credential directory. The server authenticator 325 then allows the service response 345 to flow from the server application 315 to the client application 305. The server authenticator inserts credentials as necessary if the server application requires further authentication.

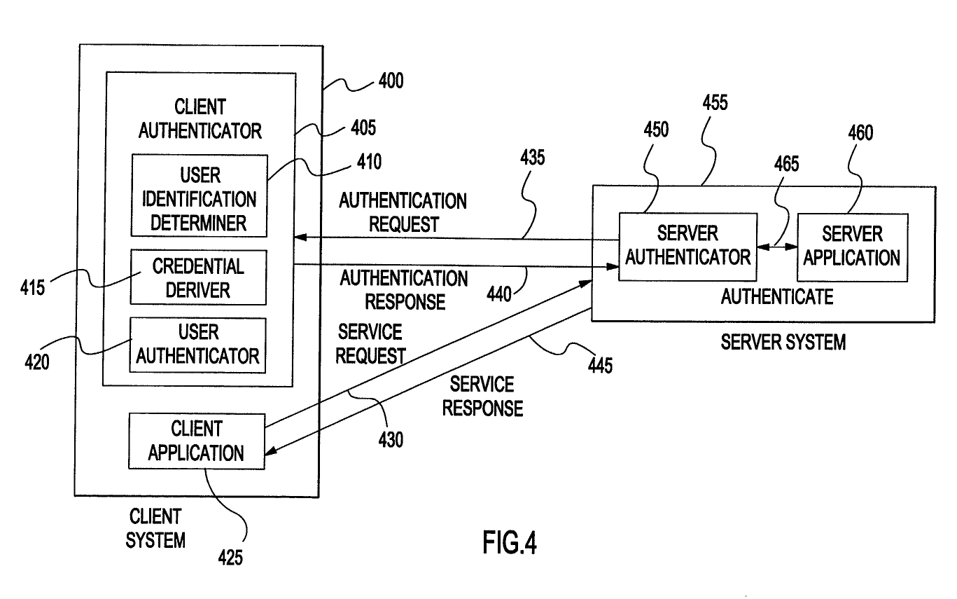

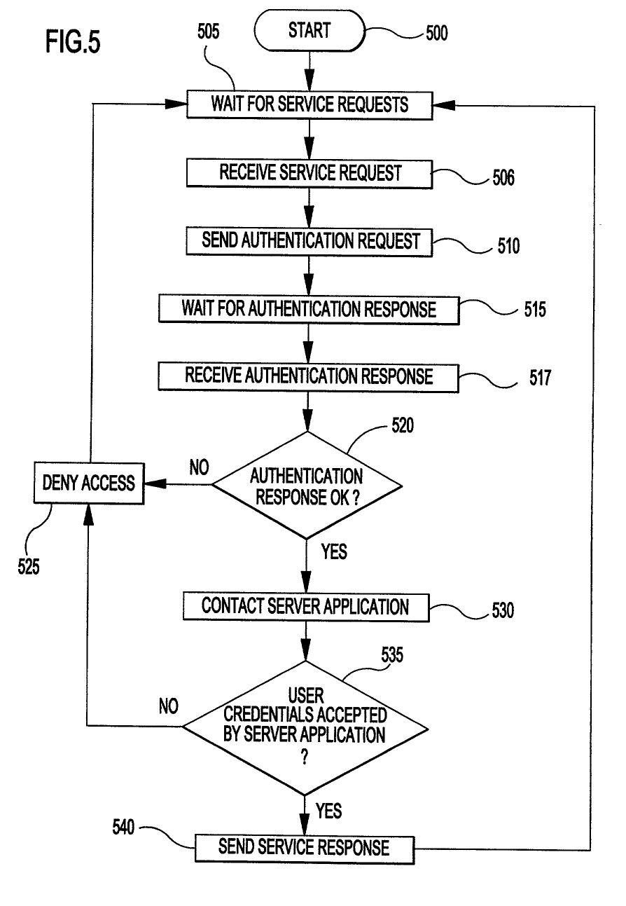

FIG. 4 shows another embodiment of the invention illustrating a technique as in FIG. 3 wherein the server authenticator 450 is installed as an intermediary, or proxy, on the server system 455 at which the server application 460 is running; and, the client authenticator 405 is installed on the client system 400 at which the client application 425 is running. When the client application makes a service request 430 for a server application, the server authenticator 450 acts as a proxy server and intercepts the service request. The server authenticator 450 then sends an authentication request 435 to the client authenticator 405 on the client system 400.

The client authenticator 405 can be contacted by the server authenticator since the server authenticator can determine the address of the client from the service request 430 and since the client authenticator listens for authentication requests on a predetermined port. The authentication request 435 will then include the client and server port numbers from the service request 430. The port numbers can be used by the client authenticator to help determine the client application from which the request was generated and which user of the client application initiated the request.

The client authenticator 405 uses a user identification determiner 410 to match the authentication request 435 to a service request 430, a client application 425, and a user, The user identification determiner may use the port number of the service request 430 and the address of the server system 455 for an operating system lookup that would indicate which client application is making the request. Additionally, an operating system lookup may be used to determine the user of the client application or which user is logged into the console associated with the port from which the request issued. Finally, a configuration file may be consulted to see which user initiated the request.

Once a user has been determined, the client authenticator uses credential deriver 415 to see if the user has already been authenticated in a way acceptable for the server system. This is done by a look-up to determine if user credentials have been stored for the user (e.g., if the user has been pre-authenticated at sign-on or has been authenticated based on a previous service request). Additionally, the client authenticator must determine if the server application accepts general pre-authorizations or if it requires a new authentication. Such information may be implicit or may be found in the authentication request.

If either the user has not been pre-authenticated or the server system or application does not accept general pre-authentications, then the user authenticator 420 performs steps to authenticate the user, possibly by employing a pop-up authentication window or by using credentials stored in a configuration file. Once the user is authenticated, user credentials are created for the user and stored for later use by the credential deriver 415. Resulting user credentials are then sent in an authentication response 440 sent from the client authenticator to the server authenticator.

The server authenticator uses the user credentials to authenticate 465 the client with the server application 460. If necessary, the server authenticator will translate the credentials into a recognized by the server application, using a credential directory or other data store. After authentication, the server authenticator serves mostly as a passive proxy, allowing the service response 445 to flow from the server application 460 to the client application 425. The server authenticator does monitor the communication stream, however, to determine if further authentication is required and/or to insert authentication credentials as needed by the server application on future service requests from the same user.

FIG. 5 shows a flowchart that illustrates the actions taken by the server authenticator 450 for the embodiment shown in FIG. 4. The flowchart is entered at step 500 whenever the device implementing the embodiment is initialized at the server system 455. In step 505, the server authenticator waits for service requests from client applications. Upon receiving a service request at 506, the server authenticator sends an authentication request 510 to the client authenticator, using the client address from the service request and a predetermined, well-known port number to address the client authenticator. The authentication request may include additional information, such as the client and server port numbers from the service request 505.

At step 515, the server authenticator waits for an authentication response from the client authenticator. Once an authentication response is received at 517, the server authenticator checks the user credentials in the authentication response at step 520. If the user credentials allow access, as determined in step 520, the server authenticator communicates with the server application in step 530 to determine if the server application will accept the user credentials. As noted above, the authentication may include steps (not shown) for translating the client credentials into a format which will be recognized by the server application.

After step 530, the server authenticator checks to determine if the client has been authenticated with the server application, in step 535. If the authentication has occurred, as determined in step 535, then the service response is sent from the server application to the client application at 540 and the server authenticator returns to wait for another service request at step 505. If the credentials in step 520 do not allow access, or if the user is not authenticated in step 535, then step 525 is executed. In step 525, the service request is denied, including the generation of a “request denied” message which is sent to the client application, and the server authenticator returns to wait at step 505.

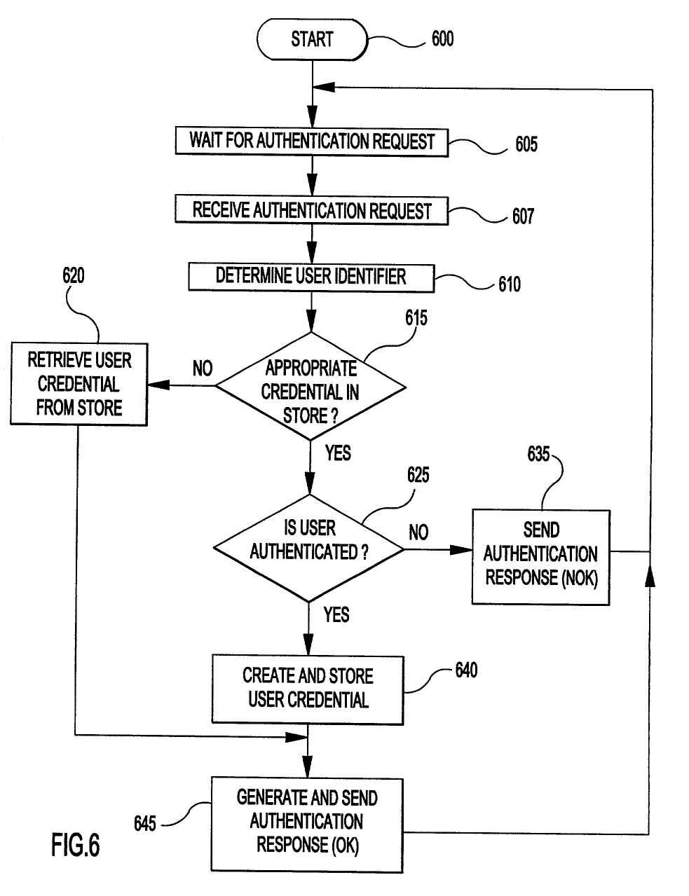

FIG. 6 shows a flowchart that illustrates the actions taken by the client authenticator 405 for the embodiment shown in FIG. 4. The flowchart is entered in step 600 whenever the device implementing the embodiment is started at the client system 400. In step 605, the client authenticator 405 waits for authentication requests from a server authenticator 450.

Upon receiving an authentication request at step 607, a user identifier is determined in step 610. Step 610 may be carried out by consulting a pre-configured configuration file or by finding the user identifier of the user logged in to the console from which the service request emanated. In one embodiment, step 610 would involve finding the client application 425 which issued the service request 430, and then using operating system calls to determine the current user of the client application who initiated the service request. The client application can be identified using port numbers from the service request 430 that may be sent as part of the authentication request 435.

Once a user identifier has been determined in step 610, the client authenticator 405 checks to see if there is already a credential stored for this user and for this server system, server application, or both, in step 615. If, in step 615, a previously-stored user credential is located, then the user credential is retrieved from the store at step 620 and is incorporated into an authentication response which is generated at step 645. If there is not a credential stored in step 615, then the client authenticator authenticates the user in step 625.

For authentication at step 625, the client authenticator may initiate an interactive authentication with the user by launching an authentication window. The client authenticator may alternatively authenticate the user by using information stored in a configuration file. If the user is successfully authenticated in step 625, then in step 640 the user credentials are created and stored for later use by the credential deriver of the client authenticator.

After creating the credentials in step 640, the user credentials are sent in the authentication response 440 to the server authenticator 450 in step 645. After step 645, the client authenticator returns to step 605 to await the next authentication request. If the user authentication is not successful in step 625, then the authentication response 440 is generated and sent to the server authenticator 450 at step 635 indicating that the user authentication has failed. The client authenticator then returns to step 605 to await receipt of the next authentication request. When user authentication includes generating a pop-up window for user input of information, the client authenticator may execute another optional series of steps (not shown) to prompt the user to re-input information, on the chance that authentication was unsuccessful due to user error in inputting the information.

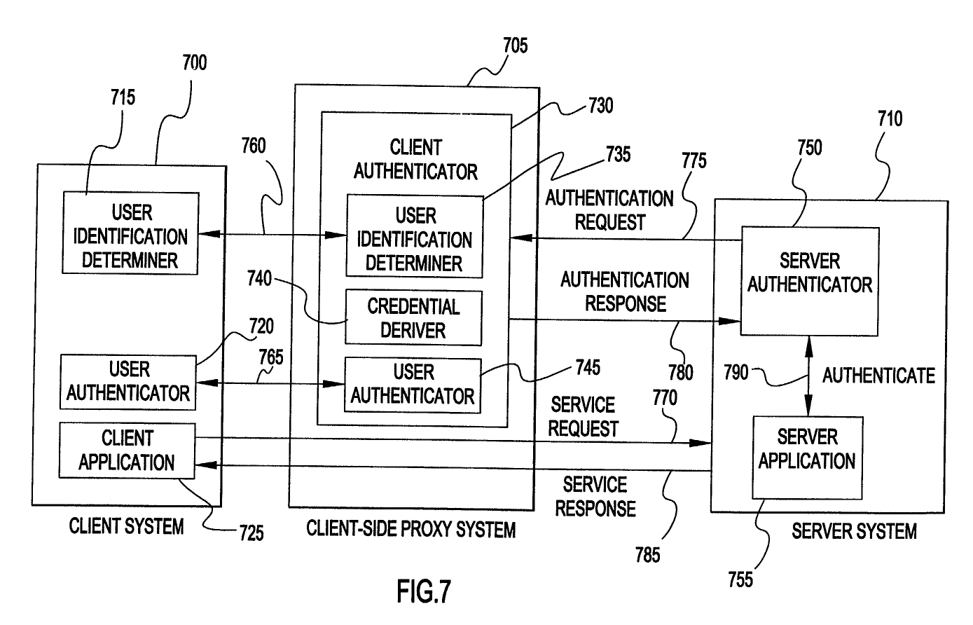

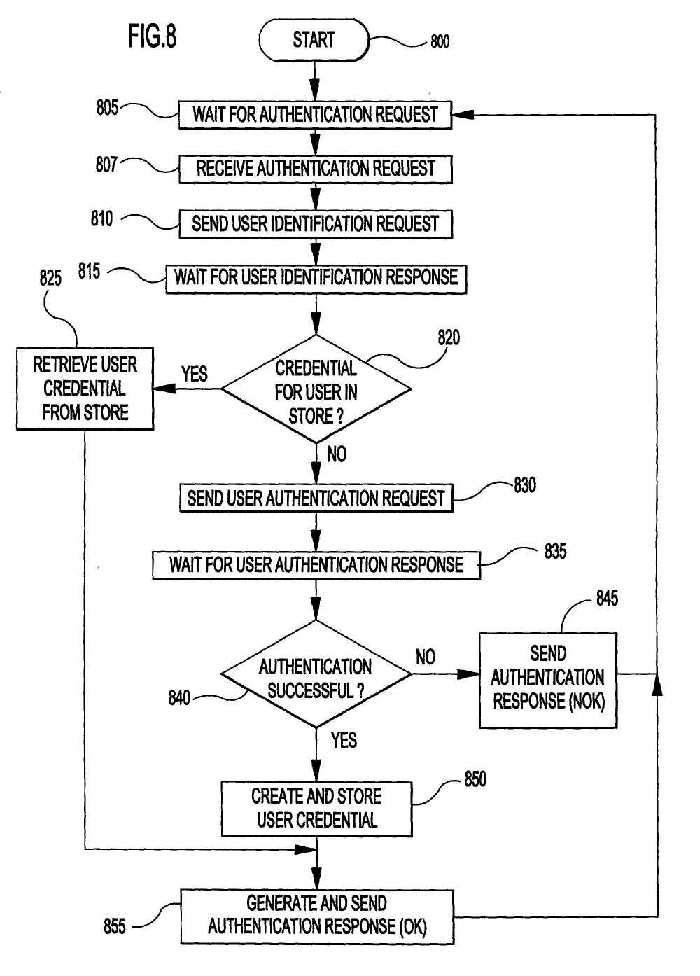

FIG. 7 shows another embodiment of the invention, illustrating a technique for enabling a client application 725 to access a server application 755 when the server authenticator 750 is a proxy installed on the server system 710 running the server application, and the client authenticator 730 is installed on a client-side proxy system 705 different from the client system 700 running the client application 725. This embodiment is particularly useful for client applications running on several pervasive devices such as cell phones, computers, and personal digital assistants owned by a single user to share user authentication credentials with minimum effort for the user.

The client application 725 makes a service request 785 that passes through the client-side proxy system 705 to the server system 710 for a server application 755. The server authenticator 750 acts as a proxy for requests to the server and intercepts the service request. The server authenticator 750 sends an authentication request 775 to the client authenticator 730 on the client-side proxy system 705 if authentication is needed.

The client authenticator 730 is directly addressed by the server authenticator because the server authenticator finds the address of the client-side proxy system in the service request 770 and the client authenticator listens on a well-known port. The authentication request 775 includes the client and server port numbers from the service request 770. The port numbers can be used by the client-side proxy system to determine which client system has made the service request by examining the proxy network address translation tables or other system data structures. The client authenticator 730 uses the user identification determiner 735 to match the authentication request 775 to a service request 770, client application 725, and user. The user identification determiner 735 can use methods detailed above with reference to in FIG. 4 to determine the user identifier.

In the FIG. 7 embodiment, the user identification determiner 735 on the client-side proxy system 705 requests 760 the user identifier from the user identification determiner 715 on the client system. The user identifier request 760 can be accompanied by the client system port number and server application port number from the service request 770. The user identification determiner 715 on the client system can determine the user identification of the client application using one of the methods detailed above with reference to FIG. 4, such as a pre-configured configuration file, or the port information to look up the client application and the user of the client application.

Once a user has been determined, the client authenticator uses the credential deriver 740 to determine if the user has already been authenticated in a way which is acceptable for the server system. If not, the user authenticator 745 proceeds to authenticate the client, possibly by using credentials stored in a configuration file. In this embodiment, the user authenticator 745 on the client-side proxy system 705 requests 765 user authentication from a user authenticator 720 on the client system 700. Alternatively, this request can be made of a user authenticator on a separate client system that comprises means to authenticate the user. The user authenticator 720 on the client system uses the techniques detailed above with reference to FIG. 4 for authentication, such as checking a configuration file or preferably initiating an interactive authentication with the user and returning the authentication to the user authenticator 745.

Once authenticated, user credentials are created at the client authenticator for the user and are stored for later use by the credential deriver 740. Resulting user credentials are then sent in the authentication response 780 from the client authenticator 730 to the authenticator 750. The server authenticator uses the user credentials to authenticate 790 the client against the server application 755, possibly including steps (not shown) for translating the credentials into a form recognized by the server application with the aid of a credential directory. The server authenticator then serves primarily as a passive proxy, allowing the service response 785 to flow from the server application 755 through the client-side proxy system 705 to the client application 725. The server authenticator continues to monitor the communication stream, however, to determine if further authentication is required and/or to insert authentication credentials as needed by the server application on future service requests by the same user.

FIG. 8 shows a flowchart that illustrates the actions taken by the client authenticator 730 for the embodiment shown in FIG. 7. The flowchart is entered in step 800 whenever the device implementing the embodiment is initiated at the client-side proxy system 705. In step 805, the client authenticator 730 waits for authentication requests from a server authenticator 750. Upon receiving a request at 807, the user identifier is requested at 810 from the client system 700 where the client application 725 is running. The user identifier request is accompanied by the client application port number and the server application port number which can be obtained from the network address translation tables or other system data structures and from the authentication request 775 received from the server system. In step 815, the client authenticator 730 waits for the user identifier from the user identification determiner 715 on the client system 700.

Once a user identifier has been determined in step 810, the client authenticator 730 checks to see if there is already a user credential stored for this user which will be acceptable for this server system in step 820. If there is not a credential stored in step 820, then the client authenticator sends an user authentication request 765 to a user authenticator 720 on a client system 700 in step 830. In step 835, the client authenticator 730 waits for a user authentication response from the user authenticator 720. After step 835, the user authentication credentials are checked in step 840. If the user is authenticated in step 840, then in step 850 the user credentials are created and stored for later use by the credential deriver of the client authenticator.

After creating the user credentials in step 850, the user credentials are sent in the authentication response 780 to the server authenticator 750 in step 855. After step 855, step 805 is executed. If in step 820, user credentials are already stored, then in step 825 the user credentials are retrieved from the store and step 855 is executed. If the user authentication is not successful in step 840, then in step 845 an authentication response 780 is sent to the server authenticator 750 indicating that the user authentication has failed. The system then returns to step 805 to await the next request.

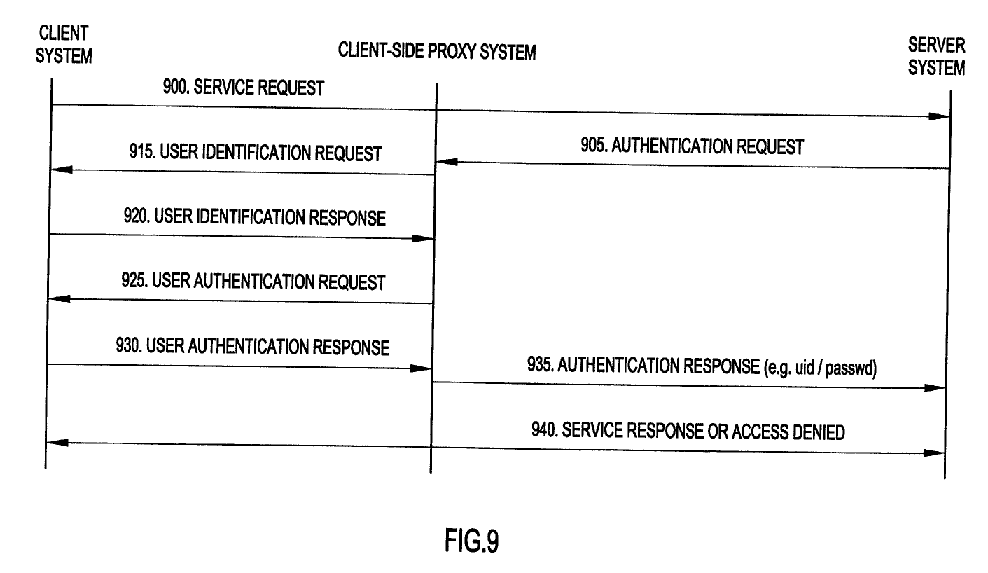

FIG. 9 shows the sequence of events for the embodiment shown in FIG. 7. A client system sends a service request 900 to the server system, which passes through the client-side proxy server. The server authenticator at the server system sends an authentication request 905 to the client authenticator on the client-side proxy system which listens on a well known port. The client authenticator on the client-side proxy system sends an user identification request 915 to the client system running the client application.

The client system then sends a user identification response 920 to the client-side proxy system. If the client-side proxy system does not already have credentials for the user, the client-side proxy system sends a user authentication request 925 to the client system. The client system sends a user authentication response 930 to the client-side proxy system. The client-side proxy system then builds and stores user credentials for the user, and submits them in the authentication response 935 to the server authenticator on the server system. Next, the server sends the service response at 940, indicating that authentication was successful or that access is denied, depending on whether or not the user credentials were accepted.

The invention has been described with reference to several representative embodiments. It will be understood that one having skill in the art could modify or combine steps without departing from the spirit and scope of the invention as set forth in the appended claims.

Having thus described our invention, what we claim as new and desire to secure by Letters Patent is:

1. A method for enabling at least one client application to access at least one server application from at least one server system comprising the steps of:
receiving at least one service request at the at least one server system from at least one client application on a client system;
sending an authentication request from said at least one server system to at least one client authenticator on said client system, wherein the client authenticator is independent of said at least one client application; and
receiving at least one authentication response to said authentication request at said at said at least one server system.

2. The method as recited in claim 1, wherein a server authenticator is installed at said at least one server system.

3. The method as recited in claim 2, wherein said server authenticator is integrated into at least one server application.

4. The method as recited in claim 2, wherein the server authenticator is implemented as a proxy service running separate from the at least one server application.

5. A method for enabling at least one client application running on a client system having at least one client authenticator which is independent of said at least one client application to access at least one server application from at least one server system comprising the steps of:
sending at least one service request to said at least one server application at said at least one server system from said at least one client application;
receiving at least one authentication request from said at least one server system at said at least one client authenticator; and
sending at least one authentication response to said at least one server authenticator from said at least one client authenticator at said at least one client system.

6. The method as recited in claim 5, wherein the client authenticator runs on a client-side proxy system provided to manage access control on the request path between said at least one client application and said at least one server application.

7. The method as recited in claim 5, wherein the step of sending at least one authentication response comprises the steps of:
identifying the user of the client application;
determining if said user is an authenticated user; and
generating an authentication response based on said determining.

8. The method as recited in claim 7 wherein said step of generating an authentication response comprises the steps of:
obtaining at least one user credential; and
sending said at least one user credential to the server authenticator.

9. The method as recited in claim 7, wherein the step of identifying the user of the client application comprises using a user identifier pre-configured into the client authenticator.

10. The method as recited in claim 9, wherein the using of said pre-configured user identifier is preceded by a step of determining if said at least one server application accepts pre-configured user identifiers.

11. The method as recited in claim 7, wherein the step of identifying the user of the client application comprises determining the user identifier of user logged into the system via the system console.

12. The method as recited in claim 7, wherein the step of identifying the user of the client comprises determining the user identifier of the user running said client application.

13. The method as recited in claim 8, wherein the step of obtaining at least one user credential comprises retrieving previously stored user credentials from storage.

14. The method as recited in claim 8, wherein the step of obtaining at least one user credential comprises the steps of:
authenticating said user;
said at least one user credential for said user; and
storing said at least one user credential.

15. The method as recited in claim 14, wherein the step of authenticating said user comprises initiating an interactive user authentication.

16. The method as recited in claim 15 wherein said initiating an interactive user authentication comprises requesting user identification information from said user.

17. The method as recited in claim 14, wherein the step of authenticating said user comprises validating a configuration file on the client system.

18. The method as recited in claim 14, wherein the client authenticator runs on a client-side proxy system for managing access control on behalf of said at least one client system, and which is on the request path between said at least one client application and said at least one server application.

19. The method as recited in claim 8 wherein the step of authenticating said user comprises requesting user authentication from a client system managed by said client-side proxy system.

20. Apparatus for enabling at least one client application to access at least one server application from at least one server system, said apparatus comprising:
at least one server authenticator to authenticate users to server applications by requesting authentication from at least one client authenticator; and
at least one client authenticator to obtain and provide authentication to at least one server authenticator.

21. The apparatus as recited in claim 20, wherein the server authenticator runs at a proxy server.

22. The apparatus as recited in claim 20, wherein the server authenticator is a proxy service on a server system.

23. The apparatus as recited in claim 20, wherein the server authenticator is part of the at least one server application.

24. The apparatus as recited in claim 20, wherein the client authenticator comprises at least one component for conducting an interactive authentication procedure to authenticate users.

25. The apparatus as recited in claim 20, wherein said at least one server authenticator comprises at least one request generating component for deriving the client port number from said client request and for generating an authentication request including at least said client port number of the client application.

26. The apparatus as recited in claim 25, wherein said at least one client authenticator determines the user of the client application by performing the steps of:
looking up the client application assigned to said client port number; and
looking up the user identifier assigned to the client application.

27. The apparatus as recited in claim 20, wherein the client authenticator runs on a client-side proxy server separate from the client system of the client application.

28. The apparatus as recited in claim 27, wherein the client authenticator is configured to request user authentication from a client system other than the client system running the client application.

29. An apparatus for enabling at least one client application access to at least one access-controlled server application comprising:
at least one server authenticator for intercepting a service request from at least one client application to said at least one access-controlled server application and for requesting user authentication from a client authenticator;
at least one client authenticator for determining a user of said at least one client application which generated said service request, for authenticating said user, and for generating an authentication response to said at least one server authenticator.

30. The apparatus as recited in claim 29 wherein said at least one client authenticator further comprises at least one credential generating component for creating and storing at least one user credential.

31. The apparatus as recited in claim 29, wherein said at least one client authenticator further comprising means for requesting a user identifier from another client system for determining said user.

32. The apparatus as recited in claim 29 wherein said at least one client authenticator comprises authentication request means for requesting another client system to perform user authentication.

33. The apparatus as recited in claim 29 wherein said at least one client authenticator further comprises a component for initiating user authentication by generating an interactive exchange with said user.

34. The apparatus as recited in claim 29 wherein said at least one client authenticator further comprises means for user authentication by deploying at least one certificate.

35. A program storage device readable by machine tangibly embodying a program of instructions executable by the machine for performing a method of enabling at least one client application to access at least one server application from at least one server system, said method comprising the steps of:
receiving at least one service request at the at least one server system from at least one client application on a client system;
sending an authentication request from said at least one server system to at least one client authenticator on said client system, wherein the client authenticator is independent of said at least one client application; and
receiving at least one authentication response to said authentication request at said at said at least one server system.

36. A program storage device readable by machine tangibly embodying a program of instructions executable by the machine for performing a method for enabling at least one client application running on a client system having at least one client authenticator which is independent of said at least one client application to access at least one server application from at least one server system, said method comprising the steps of:
sending at least one service request to said at least one server application at said at least one server system from said at least one client application;
receiving at least one authentication request from said at least one server system at said at least one client authenticator; and
sending at least one authentication response to said at least one server authenticator from said at least one client authenticator at said at least one client system.
